(19) United States
(12) Patent Application Publication
(10) Pub. No.: US 2025/0321022 A1
(43) Pub. Date: Oct. 16, 2025

(54) ELECTRONIC TORCH APPARATUS

(71) Applicant: IMPERIAL THERMAL ENGINEERING LTD, Braintree (GB)

(72) Inventor: Jonathan FORBES-BROWN, Braintree (GB)

(21) Appl. No.: 18/631,801

(22) Filed: Apr. 10, 2024

(51) Int. Cl. F24H 3/04; E04D 5/14; E04D 15/04; H05B 3/42

(52) U.S. Cl. CPC F24H 3/0423; E04D 15/04; H05B 3/42; E04D 5/148; F24H 2250/02

(57) ABSTRACT

An electric torch apparatus includes: an electric torch; a control unit for generating a flow of air to be supplied to the electric torch, the control unit having a housing with at least one air inlet and an air outlet. The housing contains a fan unit for generating the flow of air and electronic control components for controlling operation of the apparatus. A flexible hose connects the control unit to the electric torch. The electric torch includes an electrically powered heater powered by the control unit via a cable in the flexible hose. An air inlet of the control unit is arranged in a lower portion of the housing and the air outlet is arranged in an upper portion of the housing. The electrically powered heater may comprise intertwined and angularly displaced spirals of heater wires.

### FIELD

The technology described herein relates to an electric torch apparatus. It also relates to developments in an electrically powered heater used in an electric torch of the apparatus. The electric torch is primarily intended for use in roofing applications but may have applications in other areas for applying heat to surfaces.

### BACKGROUND

Roofing products, such as bitumen, are used in the sealing of roof structures. During the application of roofing membranes, bitumen-based products are melted using gas-powered roofing torches, and these are used in order to seal the membranes to the roof structure. Prior to applying the membrane, the torch may be used to prepare the area by drying the surface where the membrane is to be laid and/or to ready the membrane.

Gas-powered roofing torches come in many forms, but are generally in the form of a hand-held device comprising a lance with a nozzle at the end. The lance is coupled to a gas source, for example, a cylinder of propane or butane. The gas is burnt at the nozzle to produce a hot naked flame and generate heat, which is then used to melt the bitumen-based roofing product and/or prepare the surface beforehand. The bitumen-based materials might be incorporated into a roofing membrane or they might be heated and applied separately during sealing of a membrane.

However, the use of naked flames during the construction or repair of a building poses a tremendous fire risk and there is plenty of evidence of instances where a fire has started through the use of a naked flame from such a roofing torch. It is not only the presence of flammable gases but in such construction environments there will usually be exposed, combustible parts of the roof structure as well as combustible debris collected in the working area. In addition to safety, there are also moves to burn fewer fossil-based resources.

As a result, it would be desirable to provide an improved roofing torch, particularly one which avoids the use of a naked flame and reduces carbon consumption.

There have been a number of developments recently with electric powered roofing torches. In one known example, a backpack is provided comprising an electric fan to generate a flow of air which is directed via a flexible tube into a handheld torch provided with an electric heater matrix to heat the air. The resulting flow of hot air is then directed via a lance or nozzle of the torch to where it is needed in order to apply heat to a roofing product, e.g., a roofing membrane being used on a roof structure. This electric roofing torch solution, while offering many benefits through avoiding naked flames and reduced carbon consumption, is however quite bulky and heavy for the operator to manoeuvre, and improvements in performance are also desirable.

### SUMMARY

Viewed from a first aspect there is provided an electric torch apparatus which comprises an electric torch, a control unit and a flexible hose. The control unit is for providing a source of electrical power to the electric torch. The control unit is also for generating a flow of air to be supplied to the electric torch during operation of the electric torch. The control unit comprises a housing with at least one air inlet and an air outlet. The housing contains a fan unit for generating the flow of air. The housing also contains a plurality of electronic control components for controlling the operation of the electric torch and the fan unit. The flexible hose is for connecting the control unit to the electric torch. The flexible hose is configured to direct the flow of air from the air outlet of the control unit into the electric torch.

The electric torch comprises an electrically powered heater for heating the flow of air as the air passes through the electric torch. The electrically powered heater may comprise heater elements operating collectively, in use, at a power in excess of 20 kW to achieve temperatures at a nozzle outlet in excess of 650° F. (340° C.), typically significantly more, e.g., of the order of 750° F. (400° C.) and above. The electric torch can be used for roofing applications, such as drying a roof deck, activation of self-adhesive felt sheet products, melting bitumen-based products for welding and/or sealing roofing applications, etc., and so may be considered as an electric roofing torch. That said, the electric torch may have applications in many other situations where the hot air can be used to dry, prepare, treat and/or process surfaces. For example, the electric torch could be used for drying and/or thawing surfaces that are wet and/or covered in ice/snow.

The at least one air inlet of the control unit may be arranged in a lower portion of the housing. The air outlet may be arranged in an upper portion of the housing. The housing provides a conduit for directing air between the at least one inlet and the air outlet. In use, when the flow of air is generated by the fan unit, air is drawn into the control unit through the at least one air inlet, is drawn over the electronic control components within the housing by the fan unit and forced out through the air outlet into the flexible hose for supplying the flow of air to the electric torch. From there, the air is forced under pressure and at high speed by the fan unit, via the flexible hose, into an inlet of the electric torch, where the air is heated by the electrically powered heater within the electric torch and ejected from an outlet nozzle for application to a surface. The outlet nozzle may be a component of the electric torch downstream of the electrically powered heater, or may be an attachment such as a delivery nozzle fitted to the electric torch (e.g., through sliding, friction, clamping, screw, bayonet or other attachment) to direct the flow of heated air from the electric torch to a surface. The delivery nozzle may be in the form of an air-blade, e.g., to focus the air into a narrow band of high-velocity hot air that is capable of melting bitumen.

The fan unit may be positioned in the upper portion of the housing at the air outlet, for example, the air outlet may be arranged on a top side of the housing. The fan unit may be positioned downstream of the electronic control components and upstream of the air outlet.

The housing of the control unit may comprise a first air inlet on a first side. The housing may comprise a second air inlet on a second side. The second air inlet may be positioned opposite to the first air inlet, on that second side. The at least one air inlet may be spaced from a bottom side of the housing. The inlet(s) may be positioned in other places too and there may be more than two inlets.

The housing may be a cuboid box having a bottom side, a top side, a front side, a back side, a left side and a right side. The first air inlet may be positioned on a left side. The second air inlet may be positioned on a right side.

Advantageously, the housing is arranged to provide a conduit for facilitating the air to flow over and through gaps in the contents of the housing. In other words, the housing does not only protect/house its contents, e.g., the electronic control components of the control unit, but it is arranged in such a way so as to channel/guide a flow of air past the electronic control components in order to provide cooling to said components.

The fan unit may be located near the top of the housing, together with the air outlet, and the air inlet(s) may be located near the bottom of the housing. In this way, the flow of air is drawn up over the electronic components as it passes from the at least one air inlet to the air outlet, such that heat is taken from the electronic components and expelled from the control unit. The air outlet may be arranged on a top side of the housing. Connection of the flexible hose on a top side of the housing can make using the electric torch for typical roofing operations easier. The connection may allow some relative rotation too.

The housing of the control unit, may be made of solid panels and may be substantially airtight (apart from the air inlet(s) and the air outlet). The housing may be in the form of a box, for example, a metal box, with a hinged panel or door providing access to an interior when required. A seal may be provided around an edge of such a door. The housing may be provided with a lock to restrict unauthorised access to the interior.

The at least one air inlet may be provided with a filter, for example, a dust filter. The first air inlet and the second air inlet may each be provided with a filter. The filter(s) may be replaceable or washable.

The control unit may be provided with a set of wheels. The control unit may be provided with (e.g. be mounted on) a chassis in the form of a trolley or a cart comprising at least a pair of wheels, on which an operator may be able to manoeuvre the control unit more easily. Moreover, the trolley or cart may also serve to help stabilize the control unit when the electric roofing torch apparatus is in use.

The control unit may be provided with a bracket configured to hold the electric roofing torch when the electric roofing torch is not in use. The control unit may be provided with (e.g. be mounted on) a trolley or cart that comprises a bracket configured to hold the electric roofing torch in a stowed configuration when the electric roofing torch is not in use. The housing may be provided with mounting parts for mounting onto a chassis.

The fan unit may be a centrifugal fan blower. The fan unit may comprise a rotor having an axis of rotation. The fan unit may comprise an intake which faces in an axial direction. This may also be a horizontal direction. The fan unit may have a fan casing arranged circumferentially around the rotor which provides a tangential take-off for expelling air from an outlet aperture of the fan unit. The air may be expelled in a vertical direction.

The fan unit may have an outlet aperture of substantially the same size as the inlet of the flexible hose. The fan unit may have an outlet aperture with an internal diameter equal to an internal diameter of the flexible hose±20%, more preferably ±10%. The outlet aperture may have a diameter that exceeds 45 mm, more preferably may have a diameter of 50 mm or more. The inlet diameter of the flexible hose may be of similar dimensions, may be exceeding 50 mm, more preferably having a diameter of 55 mm or more. The flexible hose may be a convoluted hose, for example, comprising spirally-formed corrugations that allow the hose to flex in terms of direction whilst maintaining a reasonably constant outer diameter during use at operating pressures.

The fan unit may have a centrifugal casing with a casing radial measurement of greater than 60 mm, for example, greater than 100 mm. The fan unit casing may have dimensions exceeding 100 mm in an axial and a radial direction, may be exceeding 135 mm in one or both directions, for example, axial and radial dimensions of the order of 150 mm.

An example of a suitable fan unit may include the Ametek™ Windjammer Bypass Brushless AC blower. Such a fan unit may be orientated so that an internal rotor is mounted with a horizontal axis of rotation and a take-off direction is in a vertical direction. The fan unit may be able to generate rates of air flow (volumes per hour) that are in excess of 400 m³/h, more preferably in excess of 600 m³/h. This may be with speeds of air flow in excess of 80 km/h or even more than 90 km/h. In a preferred embodiment, air flow speeds of greater than 100 km/h, for example, 105 km/h or greater, are achievable from the electric torch at such volumes.

As a result of being able to provide the desired air flow volumes/speeds, the fan unit may be large/heavy. For instance, the fan unit may have a weight in excess of 2.0 kg, possibly even in excess of 2.5 kg. By locating the fan unit in a control unit that is separate from the electric torch, however, it is possible to provide an electric torch that is much lighter than one with an integral fan unit. This can be advantageous for an operator that has to support the weight of the electric torch on their arm for periods of operation. Thus, in preferred embodiments it may be possible to keep the overall weight of the electric torch down to just a few kilograms (e.g., less than 4.0 kg and preferably 3.0 kg or less than 3.0 kg). The tubular body of the electric torch (with the electrically powered heater omitted) may be made of carbon fibre and weigh less than 2 kg, preferably less than 1.5 kg, and more preferably still less than 1.0 kg. Any part where weight can be minimised will help to reduce the weight that the operator has to carry for potentially extended periods, as well as helping to improve the torch's general usability.

The electric torch should provide a flow of air with a heat density to perform roofing operations, like drying surfaces and melting bitumen-based roofing products. As a result, the electric torch apparatus will draw relatively high currents and the electronic control components within the control unit will become hot.

The electronic control components may comprise one or more solid-state relays.

The electronic control components may comprise one or more main monitor relays. The electronic control components may comprise one or more electrical connection terminals. The electronic control components may comprise one or more one or more contactor relays. The electronic control components may comprise one or more switch relays. The electronic control components may comprise one or more fan relays. The electronic control components may comprise one or more controllers. The electronic control components may comprise one or more power supplies. The electronic control components may comprise one or more fuses. The electronic control components may comprise one or more isolator power switches. The electronic control components may comprise one or more residual current circuit devices. The electronic control components may comprise one or more circuit breakers (e.g. MCBs). The electronic control components may be required in triplicate to accommodate three phases of a three phase input supply.

A set of the electronic control components may be for controlling operation of an electrically powered heater, e.g., in the form of a heater matrix and/or an array of spirally-formed heater wires comprising heater elements, in the electric torch. Electrical wires/cable(s) may connect and supply electrical current between electronic control components in the control unit and heater elements of the electrically powered heater in the electric torch. One or more cables (power cables, control cables, or an umbilical of power and control wires) may run the length of the flexible hose (within the flexible hose) to connect the control unit to the electric torch.

All major electronic power control components, which are required for the control of and/or power for the electric roofing torch apparatus during roofing operations, may be arranged completely within the housing (e.g. may be arranged within the flow of air through the housing generated for the electric roofing torch), or at least all portions of such power control components that might be affected by heat resulting from current passing through the component (for example, in the case of switches or control knobs which the user needs to be able to operate, those switch or control knob parts may be external and the remainder of the devices performing the control may be positioned within the housing in the flow of cooling air).

Operation of such power control components may be more reliable as a result of cooling from the flow of air. Heat from the electronic control components is then exhausted via the electric roofing torch. At the same time, the flow of air into the electric roofing torch may be heated by a few degrees before it reaches the heater matrix of the electric roofing torch.

The control unit may comprise a control panel for the operator to control a rate of flow, e.g., a volume and/or pressure of the flow, to be delivered for a roofing operation. The control panel may comprise one or more lights and/or a display for the operator for displaying an indication of the status of the electric roofing torch apparatus and/or a temperature, rate of flow, etc., being delivered for the roofing operation.

The electric torch may be handheld (e.g. configured to be held/carried by an operator during a roofing operation). The electric torch may comprise a carriage mounted on an outer surface of the torch, the carriage providing a sling or arm hoop for carrying the electric torch on an arm of an operator.

The carriage may comprise a control (e.g. a trigger, control panel, button) for the operator to control temperature and/or rate of flow to be delivered for the roofing operation (for example, a joystick control for controlling the delivery of hot air). The carriage may comprise a display for the operator for displaying an indication of the temperature and/or rate of flow being delivered for the roofing operation. The electric torch may comprise one or more sensors in communication with the display for providing temperature data, rate of flow data, etc.

The electric torch may be electrically connected to the control unit by wires in the flexible hose for the supply of all its power and control of its functions. The wires may be in the form of a cable which extends within the flexible hose. Such wires may be rated to carry sufficient electrical power to the electrically powered heater, for example, in excess of 22 kW and of the order of 28 kW or greater. The electrical power may be supplied to the electric torch as a three-phase supply of alternating current. The flexible hose may therefore provide a form of umbilical for the electric torch through which a three phase supply is delivered to the electric torch to power the electrically powered torch.

The electric torch may comprise: a tubular body having an upstream end and a downstream end, wherein the upstream end is fluidly connected to the flexible hose to receive the flow of air from the flexible hose; and an electrically powered heater mounted in the tubular body to heat the flow of air as it passes through the tubular body.

The tubular body may comprise a double-walled structure comprising an inner tube and an outer tube, the inner tube housing the electrically powered heater. The inner tube may also provide a conduit for the flow of air between an upstream end of the inner tube and a downstream end of the inner tube.

The outer tube may provide a housing (or outer shell) for the electric torch, the housing being configured to shield an operator from heat from the heater tube whilst the operator is holding the electric torch.

The electrically powered heater may be mounted in a heater tube which is in turn housed within the inner tube of the tubular body. In one arrangement, a heater matrix is provided comprising heater elements extending longitudinally within the heater tube and arranged to extend into the flow of air which passes through the electric torch when in use. The heater elements may be in the form of coiled resistive heater wires having a relatively narrow cross-sectional diameter of 0.5 mm or smaller, strung between supports.

In another arrangement, the electrically powered heater comprises a tubular arrangement of heater elements in the form of a plurality of spirally wound heater elements supported within the electric torch, these being supported as spiral-loops where an axis of the spiral-loops aligns with a longitudinal axis of the electric torch. The spiral-loops are substantially congruent in form, at least for a portion of their length, and are angularly displaced with respect to each other about the longitudinal axis. The spiral-loops may define substantially helical paths, e.g., intertwined helical paths, where each of the heater elements has a similar spiral-loop diameter and spiral-loop pitch. This arrangement can be seen as a tubular array of heater elements. The heater elements may be evenly spaced in a circumferential direction within the air passage.

Accordingly, the heater elements may be seen as mounted in an air passage of the electric torch in a configuration that comprises a multi-helical arrangement, for example, a triple helix arrangement using three heater wires (e.g., each corresponding to a phase of a three phase supply), or a six helix arrangement using six heater wires (e.g., where pairs of heater wires correspond to a phase of a three phase supply), or where space allows, more wires, e.g., nine heater wires (e.g., where triplets of heater wires correspond to a phase of a three phase supply), at least for a portion of the electrically powered heater.

The heater elements may be supported on a core, for example, the core extending through the electric torch to define an annular air passage between a radially outer surface of the core and a radially inner surface of the inner tube of the tubular body.

In one configuration, the heater elements/heater wires may have a relatively large wire diameter of 2 mm or more, preferably 3 mm or more, and spiral-loops of the spirals may have a relatively large spiral-winding diameter of 50 mm or more, preferably 60 mm or more, the spiral-loops encircling the core on each revolution. Each spiral-loop may extend an axial distance of more than 50 mm, preferably 75 mm or more, on each revolution. In another configuration the heater elements/heater wires may have a relatively thin wire diameter of 1 mm or less, preferably less than 0.5 mm, and while the spiral-loops of the spirals may have a similar large spiral-winding diameter and axial length, the heater wires themselves are coiled providing a (tight) coiled form extending along the spiral-loops. The coil-loops of the coiled heater wires may be less than 10 mm in diameter, preferably less than 8 mm diameter.

The tubular array of heater elements may be in the form of dual concentric arrays of spirally wound heater elements, for example, comprising a radially inner array and a radially outer array of heater elements that the air passes through and over as the air passes in an axial direction through the electric torch. The heater elements of the radially inner array (formed as intertwined spirals) may continue at one end of the heater in a radially outward direction, or in the middle of the heater, and be re-directed back along the electric torch over the radially inner array to provide the heater elements of the radially outer array. In doing so, the spiral direction of the radially inner array may be opposite to the spiral direction of the radially outer array. The ends of the heater elements (the ends of the heater wires) may be located at an upstream end of the electrically powered heater (where it is much cooler).

The number of heater elements providing spiral-loops in the radially inner array may be the same as the number of heater elements providing spiral-loops in the radially outer array (e.g., six heater wires), or they may be fewer. In another arrangement, the heater elements are spirally wound as a radially inner array and a radially outer array, but the heater elements of the concentric tubular arrays are different. The number of heater elements in the radially inner array may be the same in the radially outer array, or there may be fewer heater elements making up the radially inner array (e.g., to provide a more uniform spacing of heater wires). The number of spiral-loops in each of the radially inner and radially outer arrays may be the same or there may be fewer spiral-loops in the radially inner array.

A tubular passage may be present between the radially inner array and the radially outer array to allow air to pass through in an axial direction, largely unobstructed by the heater elements (in the case of coiled heater wires, these passages may be relatively small as air can pass through the coils of the coiled heater wires). Each tubular array of spirally formed heater elements (heater wires), when viewed end on in an axial direction, may be seen as a ring having a radial thickness generally corresponding to two or three heater element/wire diameters, leaving a tubular passage for air to pass through having a radial width corresponding to one or two heater element/wire diameters.

A further (radially inward) tubular passage may be present between the radially inner array and a core of the heater and/or between the radially outer array and an inner surface of a housing (radially outward).

In another arrangement, a third tubular array of spirally wound heater elements may be provided, for example, radially inwardly of the radially inner array mentioned above, or radially outwardly of the radially outer array mentioned above. Further or other tubular arrays of heater elements (wires or coiled wires) may also be provided according to space available.

Each of the heater wires of a tubular array of heater wires may be arranged one after the next, each following a substantially parallel spiral path to a neighbouring heater wire and each angularly displaced from a neighbouring heater wire, for example, in an anti-clockwise direction looking along a longitudinal direction of the electric torch. There may be a sequence in an axial direction of three, or more preferably six heater wires, each heater wire wound in a spiral over supports extending radially from the core (the spirals being in the same direction and of substantially the same spiral-loop diameter).

Such a heater matrix of concentric tubular arrays of intertwined spirals of heater elements allows for effective heating of the air while minimising loss of air velocity.

Loops of spirally wound heater elements may be supported on axially and radially extending supports, for example, resembling fins, extending along a core of the heater. The supports may be provided with a plurality of formations for locating the heater elements within the electrical heater. These may be in the form of apertures that the heater elements would extend through in a substantially circumferential direction, but are more preferably in the form of slots, that the heater elements can be wound into or supported in to form the spiral loops. These may be in the form of radially extending slots, though slot shapes which are more organic in shape are preferred, optionally comprising a dendritic-like shape, where generally radially extending slots are provided with axially extending micro-slots to provide different radial positions for locating the heater elements/heater wires as they pass through the supports.

Each of the supports may comprise a series of such formations along a radially outer portion and/or radially inner portion, for the spiral loops to pass through, each heater element passing through each support in turn in order to locate the heater elements in position. The formations in the supports may support the relatively wide heater wires with a spacing of between 5-40 mm, more preferably 10-30 mm, as the loops spiral around a core of the heater, and in the case of coiled heater wires a spacing of between 2 to 30 mm may be adequate, more preferably 3 to 10 mm. Spirals of the heater wires may be arranged intertwined and angularly displaced from a next heater wire.

The supports may be on the form of straight strips of material, for example, a mica or other heat-resistant, insulative material, that are arranged to project radially outwardly from (or spaced from and project radially outwardly from) a core or central region of the electrically powered heater. The strip-like supports may be aligned longitudinally with an axis of the electric torch.

The supports may comprise support portions, for example, a radially inner support portion with formations along a radially outer edge for heater wires to nest in, and a pair of radially outer support portions, each provided with formations along a radially inner edge to locate over the heater wires supported on the radially inner support portion, and with formations along a radially outer edge to locate continuations of the same or further heater wires in a second tubular array of heater wires which is spaced radially outwardly from a first. Thus, the radially inner support portion and the pair of radially outer support portions may define a Y-shape when viewed in an axial direction. A retaining ring provided with spacers to locate the supports may link all the supports (and radially inner/outer support portions) together in a circumferential direction.

In another arrangement, the supports may follow a helical path around the core in an axial direction.

The tubular arrays of heater elements provided in an electric torch to form the electrically powered heater, such as in the arrangements described above, have been found to work particularly well in combination with the control unit that has been provided with a fan unit, for example, as described above, due to the speed and volume of the airflow that can be developed through the electric torch and the operating temperatures that can be obtained by the electric torch at such air flow speeds and volume.

Thus, viewed from a second aspect, there is provided an electric torch. The electric torch comprises a generally cylindrical housing providing a longitudinal axis, an air passage therethrough and an electrically powered heater in the air passage. The electrically powered heater comprises a plurality of spirally (helically) arranged heater elements for heating up air passing through the passage. The spirally arranged heater elements are supported by a plurality of radially extending supports. The heater elements are held radially, axially and circumferentially in position by the plurality of radially extending supports, each support comprising formations for locating the heater elements within the air passage. The heater elements are angularly displaced about the longitudinal axis and spirals of the heater elements are intertwined to provide one or more tubular arrays of heater elements extending along the longitudinal axis, the heater elements each following a spiral path substantially parallel to a neighbouring heater element in the tubular array, at least for a portion of the electrical heater.

That portion may, for example, correspond to an axial length for one of the heater elements to provide a full revolution whilst intertwined with five further heater elements.

Viewed another way, the heater elements of a tubular array may be seen as a triple helix or six-helix arrangement of heater elements, the relative angular displacement between the heater elements ensuring that one heater element is spaced from a neighbouring heater element throughout a helical path of each helix so that their separation remains substantially constant along the respective helical paths.

The radially extending supports may be provided as strips of material extending in the axial direction of the electric torch as well as radially to support the heater elements. The formations provided in the radially extending supports may be able to support the heater elements at one or more radial heights within the air passage. The electric torch may be an electric roofing torch capable of heating hot air directed at a working surface to temperatures in excess of 650° F. (340° C.).

The heater elements may be in the form of spirally wound wires, e.g., relatively wide/stiff wires that have been wound as large spiral-loops around the radially extending supports, or as spirally wound, filament-sized, e.g., relatively narrow/flexible wires that have been wound as large spiral-loops of coiled heater wire around the radially extending supports.

In one arrangement, a core extends along the longitudinal axis of the electric torch within the housing. The core may be a cylindrical core. The air passage is an annular air passage, provided between the housing and the core, e.g., defined by an inner surface of the cylindrical housing and an outer surface of the cylindrical core. The electrically powered heater is arranged longitudinally within the annular air passage to heat a flow of air as it passes through the annular air passage. The electrically powered heater comprises one or more tubular arrays of spirally wound heater elements (heater wires), the tubular arrays extending along the longitudinal axis. The heater elements are held radially, axially and circumferentially in position by a plurality of radially extending supports. Each support comprises formations for locating a plurality of the heater elements within the air passage. Spirals of the heater elements are angularly spaced and intertwined. In this way each heater element making up a tubular array follows a spiral path substantially parallel to a neighbouring heater element, where each heater element is angularly displaced from a neighbouring heater element.

The spirals (e.g., spiral-loops) of the heater elements are intertwined in the sense that the heater elements may start from substantially similar axial positions, and through their relative angular displacement with respect to each other, each provide at least a portion of a helix of a multi-helix structure made up of the heater elements with each heater element maintaining a substantially constant separation from a neighbouring heater element. The heater elements may be arranged as a triple (or more) helix structure in each of the tubular arrays of heater elements extending concentrically within an annulus of the annular air passage.

In this aspect, the electric torch described above may include any of the optional features of the previously described electric torch in the first aspect, especially in relation to the electrically powered heater. The electric torch may also be used with an external fan set up, for example, as described above where a fan unit is provided in a control unit to drive air from the control unit via a flexible hose into the electric torch and out through an outlet nozzle to a surface where hot air is being applied for a heating operation such as a roofing operation.

The electric torch may comprise a delivery nozzle fitted to a nozzle outlet provided on the downstream end of the tubular body to direct hot air from the nozzle outlet of the tubular body for use in a roofing operation. In one example, the nozzle may comprise a wide air blade having a blade width of 200 mm or more. In another example, the nozzle might direct the heated air into a horizontally or vertically orientated band of high temperature, high-speed air.

The roofing operation may comprise melting a bitumen-based product for welding a bitumen-based roofing felt/membrane to a roof surface. It may require temperatures in excess of 650° F. (340° C.) at the nozzle outlet. The roofing operation may comprise drying a region of roof in preparation for application of a bitumen-based roofing felt/membrane.

The electric torch may comprise an input nozzle fitted to an inlet provided on the upstream end of the tubular body to direct air from the flexible tube into the inner tube of the tubular body of the electric torch. The input nozzle may be a divergent nozzle, e.g., a divergent conical nozzle.

The collection of features provided by at least the preferred embodiments work together to result in an electric torch apparatus that is:
lightweight to use,
easy to manoeuvre during roofing operations,
is free of naked flames,
does not use flammable products, and/or
is able to produce the heat, volume and flow of air required for the roofing operations, such as laying roofing membranes, with zero or minimal carbon emissions.

Viewed from a further aspect there is provided a method of providing a heated flow of air (a working flow of air) for a roofing operation (or other industrial heating operation) using the electric torch apparatus described above, the method comprising: generating, using the fan unit, a flow of air for the electric torch; and directing the flow of air from the air outlet of the control unit to the electric torch through the flexible hose; wherein the generating the flow of air for the electric torch includes drawing the air into the control unit through the at least one air inlet, drawing the air over the electronic control components within the housing, and forcing the air out through the air outlet into the flexible hose and the electric torch.

The method may comprise heating the flow of air (the working flow) using an electrically powered heater mounted in a tubular body of the electric torch to heat the flow of air as it passes through the tubular body from an upstream end to a downstream end of the tubular body. The electrically powered heater may receive all its electrical power from the control unit, for example, via a power cable running the length of the flexible hose to the electric torch. The electric torch may be as described above in relation to the second aspect, comprising tubular arrays of spirally wound heater elements arranged to spiral around an air passage of the electric torch.

### BRIEF DESCRIPTION OF THE DRAWINGS

Certain exemplary embodiments will now be described in greater detail, by way of example only, and with reference to the accompanying drawings, in which:

FIG. 1 shows a front perspective view of an exemplary electric torch apparatus;

FIG. 2 shows a cross-sectional view of the electric torch of the apparatus of FIG. 1;

FIG. 3 shows a rear perspective view of the electric torch of the apparatus of FIG. 1;

FIG. 4 shows a front perspective view of the electric torch apparatus of FIG. 1 when the electric torch is stowed and not in use;

FIG. 5 shows a front view of the control unit of the electric torch apparatus of FIG. 1;

FIG. 6 shows a right side view of the control unit of FIG. 5;

FIG. 7 shows a left side view of the control unit of FIG. 5;

FIG. 8 shows a perspective view of an inner side of the door of the control unit of FIG. 5;

FIG. 9 shows a perspective view of the interior of the control unit of FIG. 5;

FIG. 10 shows schematically a diagram of a flow of air generated through the housing of the control unit of FIG. 5;

FIG. 11 shows a flow diagram of a method of providing a working flow of air for a roofing operation;

FIG. 12 shows a perspective view of an exemplary electric torch with a region of housing removed showing an arrangement of heater wires for an electrically powered heater;

FIG. 13 shows an end view of the arrangement of heater wires in FIG. 12;

FIG. 14 shows a side view of a support portion for supporting heater wires within an electrically powered heater of an electric torch;

FIG. 15 shows a set of exemplary supports for supporting the heater elements for use in an electric torch;

FIG. 16 shows a schematic representation of an end view of an assembled set of supports of FIG. 15 arranged in an electrically powered heater (with the heater wires omitted);

FIG. 17 shows an end view of an electric torch with the supports installed and the heater wires visible;

FIG. 18 shows an exemplary display for use with the control unit shown in FIGS. 1 and 4; and

FIG. 19 shows a schematic side view of an exemplary electric torch mounted on a chassis for use as a podium deck dryer.

### DETAILED DESCRIPTION

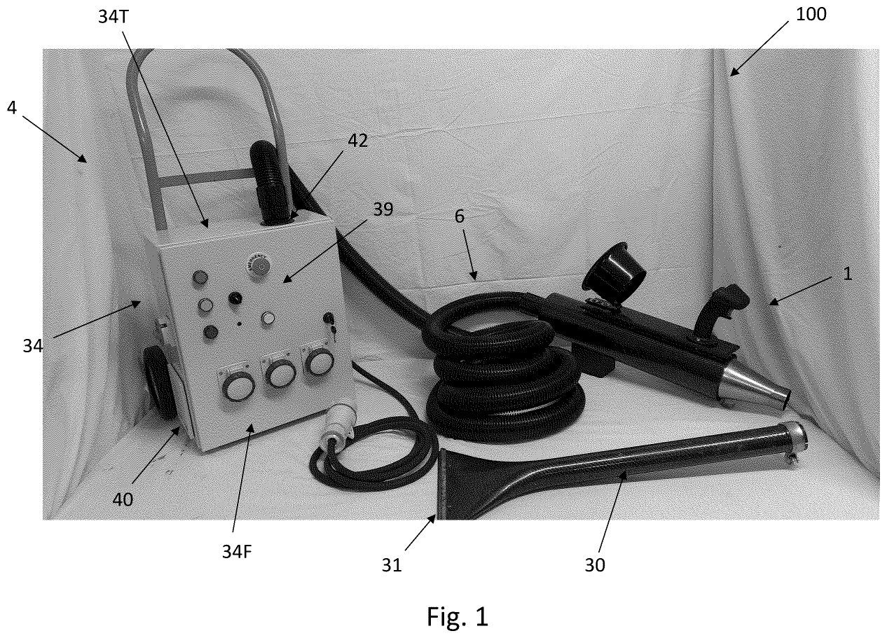

As shown in FIG. 1, there is provided an electric torch apparatus 100 comprising an electric torch 1, a control unit 4 for generating a flow of air to be supplied to the electric torch 1, and a flexible hose 6 connecting the control unit 4 to the electric torch 1, the flexible hose 6 being configured to direct the flow of air from the control unit 4 into the electric torch 1. The electric torch 1 may be designed for use as an electric roofing torch 1, and used for generating substantial amounts of heat via an electrically heated air flow to dry areas and/or activate roofing felt materials for roofing operations, in place of a gas-powered roofing torch.

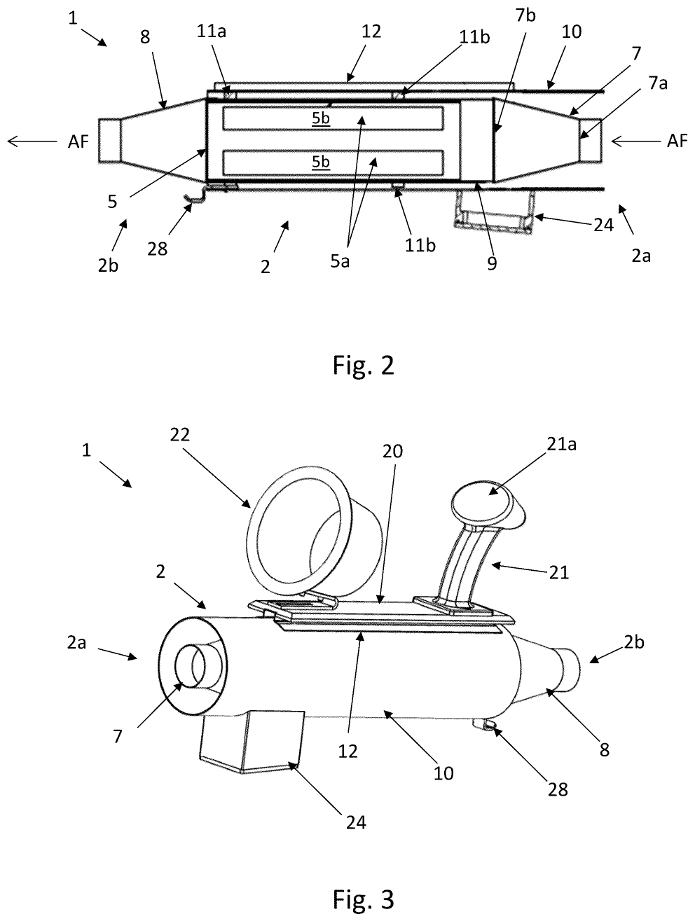

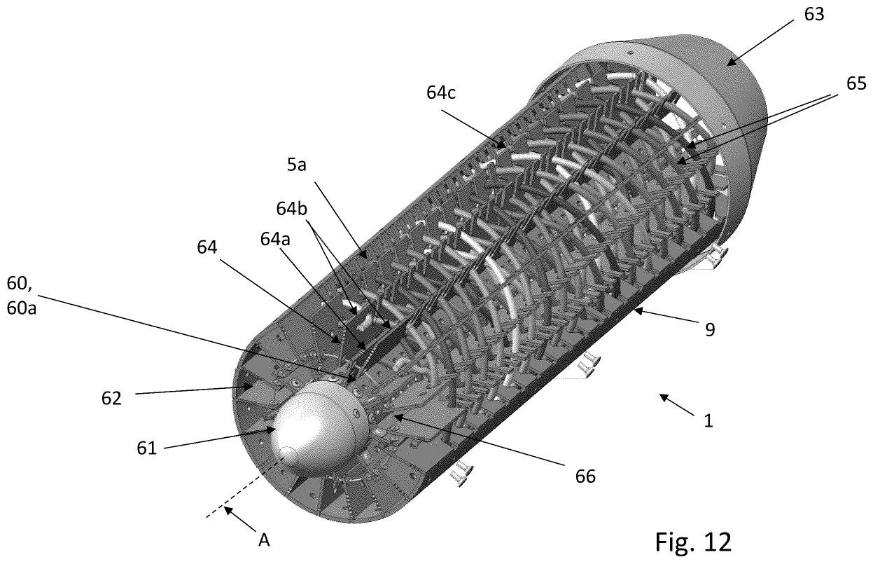

The electric torch 1 comprises a tubular body 2 having an upstream end 2a and a downstream end 2b. As shown in FIGS. 2 and 3, a heater tube 5 is provided within the tubular body 2 comprising an electrically powered heater 5a. In this arrangement the electrically powered heater 5a is in the form of a heater matrix 5a comprising an arrangement of a plurality of electric heater elements 5b. The heater elements 5b may be provided by a plurality of (relatively thin) resistive coiled heater wires supported on ceramic supports, the heater wires being strung across the path of the air by the supports. The heater elements 5b may be zoned to regions of the electrically powered heater 5a (radial, longitudinal, circumferential, etc). An alternative electrically powered heater 5a for the heater tube 5 is described with reference to FIGS. 12 to 17, where the heater elements are arranged in intertwined spirals to provide a (pseudo) multi-helical tubular array of heater elements 65, where each of the spirals is angularly displaced for a neighbouring heater element 65. The heater tube 5 in FIGS. 2 and 3 is mounted in the tubular body 2 to heat the flow of air as it passes through the tubular body 2.

As shown in FIGS. 2 and 3, a conical nozzle inlet 7 (divergent conical nozzle) is provided at a first, upstream end 2a of the tubular body 2 and a conical nozzle outlet 8 (convergent conical nozzle) is provided at a second, downstream end 2b thereof opposite the first end 2a. The tubular body 2 is arranged to guide air from the inlet 7 through the heater tube 5 towards the outlet 8. The inlet 7 is configured to be connected to the flexible hose 6 and to receive a flow of air via the flexible hose 6.

For example, as shown, the tubular body 2 comprises a double-walled structure comprising an inner tube 9 and an outer tube 10, with a plurality of spacers 11a, 11b arranged between an outer surface of the inner tube 9 and an inner surface of the outer tube 10. The electric torch 1 comprises a conical nozzle inlet 7 at the upstream end of the tubular body 2, the flexible hose 6 connecting to a narrow end 7a of the conical inlet 7 to direct the flow of air into the inner tube 9 of the tubular body 2 at a wider end 7b of the conical inlet 8, wherein the outer tube 10 extends axially over the conical inlet 7 for a distance equal to or greater than a length of the conical inlet 7.

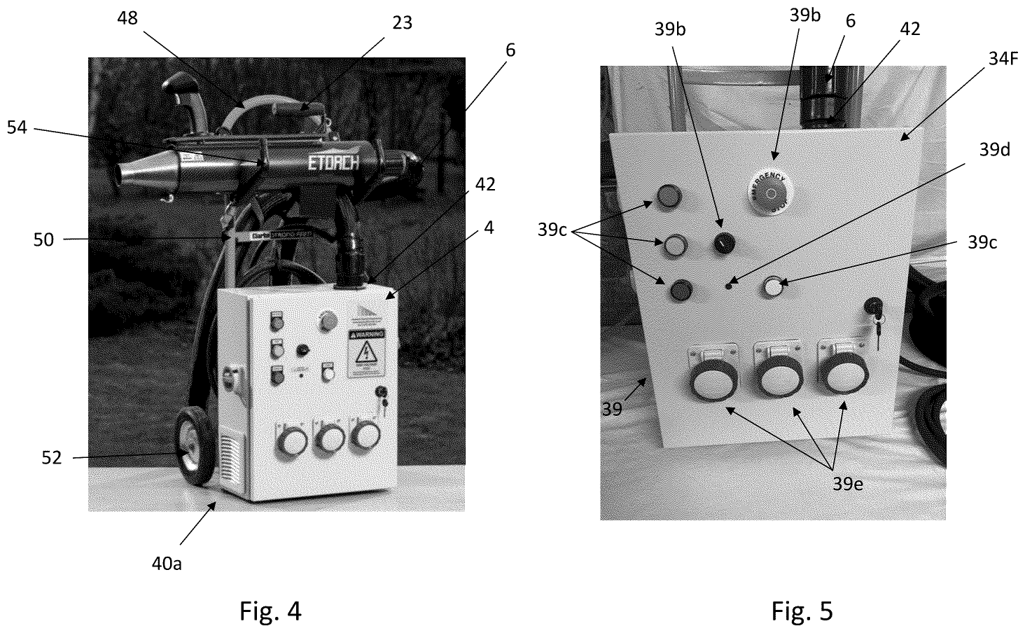

A mount 12, for example in the form of a track, is provided on an upper surface of the outer tube 10. A carriage 20 may be fitted to the mount 12 as shown in FIG. 3. The carriage may be provided with a set of controls 21, for example, in the form of a joystick or throttle/handle through which the operator can carry and operate the torch with one hand. The controls 21 may comprise a display 21a of some form. The display 21a may comprise a few LEDs to indicate operational levels. A sling or arm hoop 22 may be provided that an operator can rest on their arm whilst carrying and operating the torch 1. Other ways of carrying the electric torch and/or controlling the operation of the torch are also possible, for example, a secondary handle 23 (see the embodiment in FIG. 4) to transfer the weight of the torch for the operator's other hand, such that the torch may be carried with two hands. The electric torch may be mounted below the operator's arm as shown or may be positioned extended from the arm, for example, closer to a working surface.

The electric torch 1 may also be incorporated into a stand or handling apparatus, such as a felt handler apparatus or a trolley, for directing a source of hot air at a working surface while the weight of the electric torch is supported, for example, for when drying surfaces or when welding or activating roofing felt/membrane products.

Also visible in FIGS. 2 and 3 is a junction box 24 for where the power comes into the electric torch 1. The electric torch 1 may also comprise a bracket 28, provided on an underside of the electric torch 1, configured to provide a foot for when the electric torch 1 rests on the ground between roofing operations.

The electric torch 1 may also comprise a lance or delivery nozzle 30, e.g., as shown in FIG. 1. As shown in FIG. 1, the lance or delivery nozzle may comprise a blade-shaped aperture 31 to provide a wide flat jet of hot air for use in the roofing operation. Other types of nozzle are envisaged depending on the application and how the heat is to be applied.

The construction and dimensions of the components of the electric torch 1 discussed above may be as described in PCT/GB2021/050401 (WO-A-2021/165684), which is incorporated by reference herein in its entirety as if set forth at length.

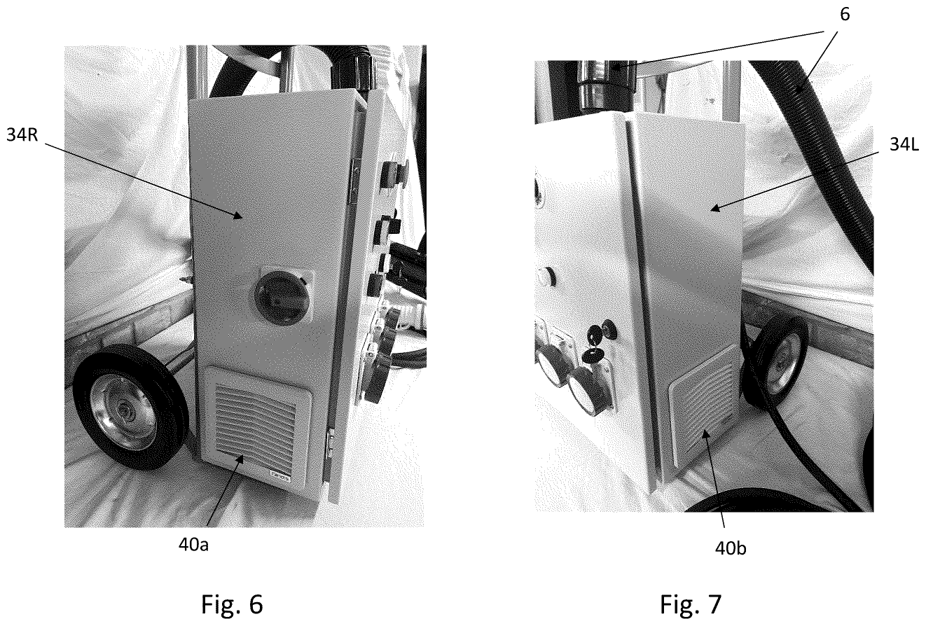

Turning to FIGS. 4-10, the depicted embodiment of the control unit 4 comprises a cuboid housing 34 having a base 34B (se FIG. 9), a back side 34BS (see FIG. 9), a front side 34F, a left side 34L, a right side 34R, and a top side 34T. The cuboid housing 34 contains a fan unit 36 for generating a flow of air AF and a plurality of electronic control components 38 for controlling operation of the electric torch apparatus 100.

To facilitate the generation of the flow of air AF (by the fan unit 36) through the housing 34, the housing 34 is provided with at least one air inlet 40 and an air outlet 42. The at least one air inlet 40 of the control unit 4 is arranged in a lower portion of the housing 34 and the air outlet 42 is arranged in an upper portion of the housing 34. Accordingly, the flow of air through the housing from the at least one air inlet 40 to the air outlet 42 is drawn over/through the electronic control components 38 (in the housing 34, between the at least one inlet 40 and the air outlet 42) before being directed to the electric torch 1 by the flexible hose 6. Thus, the flow of air AF being directed to the electric torch 1 cools the electronic control components 38 as it is drawn through the housing 34, and vice versa, the electronic control components 38 may tend to heat the flow of air AF (albeit not to a large extent) prior to it being directed to the electric torch 1.

In the embodiment shown in FIGS. 4-10, and schematically represented in FIG. 10, the housing 34 comprises two air inlets 40: a first air inlet 40a on a first side (right side 34R) and a second air inlet 40b on a second side opposite to the first side (left side 34L). Whilst the (one or more) inlets 40a, 40b are arranged in a lower portion of the housing 34, they are spaced apart from the bottom side of the housing 34 in order to mitigate the amount of dust/dirt from the roofing site that may be entrained in the flow of air AF through the inlets 40a, 40b. Each inlet 40a, 40b comprises a filter 44a, 44b to restrict any dust/dirt from the roofing site that is entrained in the flow of air AF from entering the housing 34 through the inlets 40a, 40b.

As seen in the embodiment shown in FIGS. 4 and 5, the air outlet 42 is arranged on the top side 34T of the housing 34, and the flexible hose 6 is connected to the air outlet 42.

The housing may be over 400 mm tall, over 300 mm wide and over 120 mm deep. It may comprise a volume of at least 0.015 m³, more preferably at least 0.03 m³. The air inlets may be larger than 80 mm by 80 mm, and each provide an intake area of more than 250 mm². The flexible hose be at least 45 mm in diameter, more preferably at least 55 mm in diameter, and the air outlet sized accordingly, to provide an outlet area of greater than 140 mm², more preferably greater than 170 mm².

The control unit 4 may be configured for connection to high voltage supply, for example, a US-style 480V, 3-phase, 32 A supply (or, for example, a 415V, 3-phase, 32 A supply in UK and Europe), and it may have a power consumption of around 28 KVA (22 Kw/hr) during operation.

The electric torch 1 may be able to reach temperatures in excess of 650° F. (340° C.), more preferably temperatures in excess of 750° F. (400° C.), and more preferably still temperatures in excess of 930° F. (500° C.). The electric torch 1 may be designed for use as an electric roofing torch 1 and used in place of a gas-powered roofing torch know in the art for conventional roofing operations.

In the embodiment in FIG. 9, the fan unit 36 for the electric torch 1 is positioned adjacent to the air outlet 42. Thus, in operation, the fan unit 36 is configured to inject the generated air flow AF directly into the flexible hose 6 through the air outlet 42. It is particularly noted therefore that the fan unit 36 is positioned at the top of the housing 34—going against conventional philosophy that the heaviest components should be located at the bottom of a structure (e.g. in order to improve stability of the structure). In this case, the disadvantage of positioning of the (heavy) fan unit 36 at the top of the housing 34 is out-weighed through achieving greater advantages by facilitating the flow of air AF over and through the electronic control components 38 located in the housing 34.

Thus, with reference to FIG. 10, the housing 34 is advantageously arranged to provide a conduit (e.g. an enclosed chamber or plenum space) for facilitating circulation of the generated airflow over and through the contents of the housing 34. In other words, the housing 34 protects/houses its contents, e.g. the electronic control components 38 of the control unit 4, but additionally, is arranged in such a way so as to channel/guide a flow of air past the electronic control components 38 in order to provide cooling to said components 38. The fan unit 36/air outlet 42 is located near the top of the housing 36, and the air inlet(s) 40a, 40b are located near the bottom of the housing 36, such that the flow of air is drawn through or at least over the electronic components 38 (distributed throughout the middle of the housing 34), heat being transferred from the electronic components 38 to the airflow as it passes through the housing 34 from the air inlet(s) 40a, 40b to the air outlet 42 before being directed to the electric torch 1.

FIG. 10 shows the flow of air AF in a schematic way passing up through the housing 34. In practice, the fan unit 36 may be a centrifugal fan blower where the air is drawn in through an axially-facing intake 36i where the axis of the fan unit 36 is mounted horizontally, and expelled through a tangential take-off 360 which is arranged vertically in order to exit from the top side 34T of the housing 34. The fan unit 36 may be positioned closer to one of the left or right sides 34L, 34R in order to position the intake 36i of the fan unit 36 more centrally within the housing 34 (in FIGS. 5 and 9, the fan unit 36 is positioned closer to the left side 34L so that the intake 36i is positioned approximately midway in a width direction within the housing 34, such that the tangential take-off 360, through an outlet aperture (not shown) at the top end of the fan unit casing, and the air outlet 42 are positioned at around two thirds of the way along the top side 34T. This means that in practice the flow of air AF would take a more convoluted path near the intake 36i of the fan unit 36 than shown schematically in the figure.

The fan unit 36 shown is a centrifugal fan blower, such as the Ametek™ Windjammer Bypass Brushless AC blower. The fan unit 36 is able to generate volumes of air flow from an outlet aperture (a blower port) that are in excess of 400 m³/h with speeds of air flow in excess of 80 km/h or even more than 90 km/h. In a preferred embodiment, air flow speeds of greater than 100 km/h, for example, 105 km/h or greater, are achievable from the electric torch 1. It should be noted that, in order to provide these (reasonably high) air flow volumes/speeds, the fan unit 36 can be quite large and heavy. For example, the fan unit 36 shown in FIG. 9 may have a weight in excess of 2.5 kg.

The fan unit 36 may include a hole 36h in the casing providing the tangential take-off 360 that leads to the outlet aperture and the air outlet 42. The hole 36h in the casing may be provided for directing one or more electrical leads 41 through (see FIGS. 9 and 10) and into the flexible hose 6 from inside the control unit 4. The electrical leads 41 can then be carried via the flexible hose 6 into the upstream end of the electrical torch 1. The electrical leads 41 may supply electrical power from the control unit 4 to the heater matrix 5a of the electrically powered heater that is located within the electric torch 1. Each of the heater elements 5b of the heater matrix 5a may be controlled via the electronic control components 38 located within the housing 34 of the control unit 4. Additional control wires may be provided to enable the joystick controller to function and feedback control signals via the control wires to the control unit 4. The electrical leads 41 may be provided as a bundle of wires or as an umbilical in the flexible hose 6. The electrical leads 41 may permanently connect the electric torch 1 to the control unit 4 via the flexible hose 6, in the sense that the electric torch 1 is not intended to be separated from the control unit 4 between periods of operational use.

The flexible hose 6 and electrical leads 41 may be provided as a 5 m long hose (or umbilical). Other hose lengths, such as 10 m or 20 m lengths, for example, may be available.

The electronic control components 38 generally will include a range of different types of electronic component for the control and operation of the electric torch apparatus 100. These may take the form of relays, for example one or more solid-state relays 38a, one or more main monitor relays 38b, one or more contactor relays 38d, one or more switch relays 38c, one or more fan relays 38f. These electronic control components may take the form of logic circuit components, for example, one or more controllers/processors (e.g. PLC) 38g. These electronic control components may take the form of power components, for example one or more power supplies 38h. These electronic control components may take the form of electrical safety/connection components, for example, one or more electrical connection terminals 38c, one or more fuses 38i, one or more isolator power switches 38j, one or more residual current circuit devices 38k, and one or more circuit breakers 381.

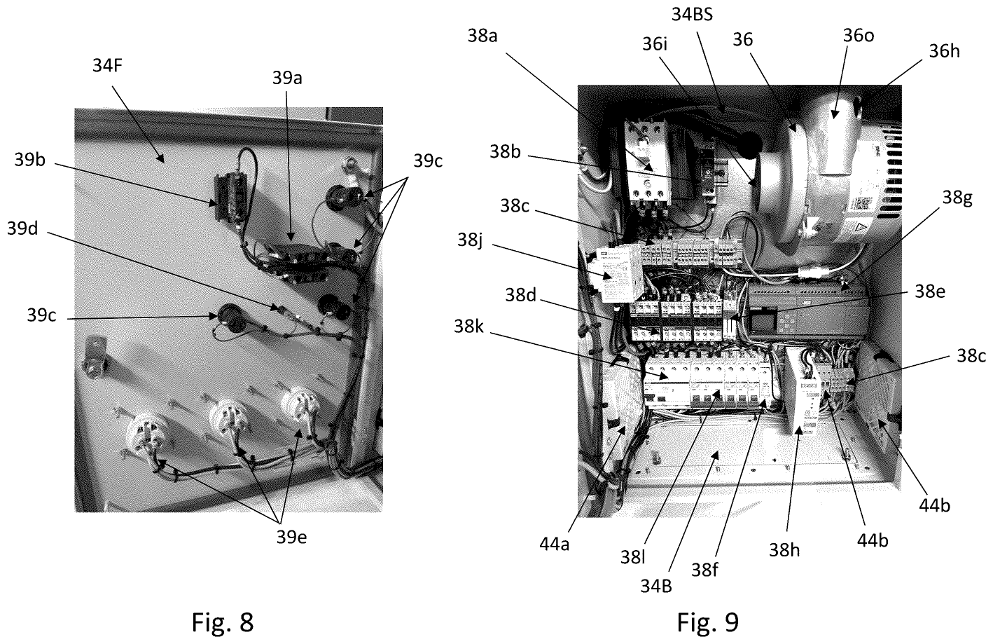

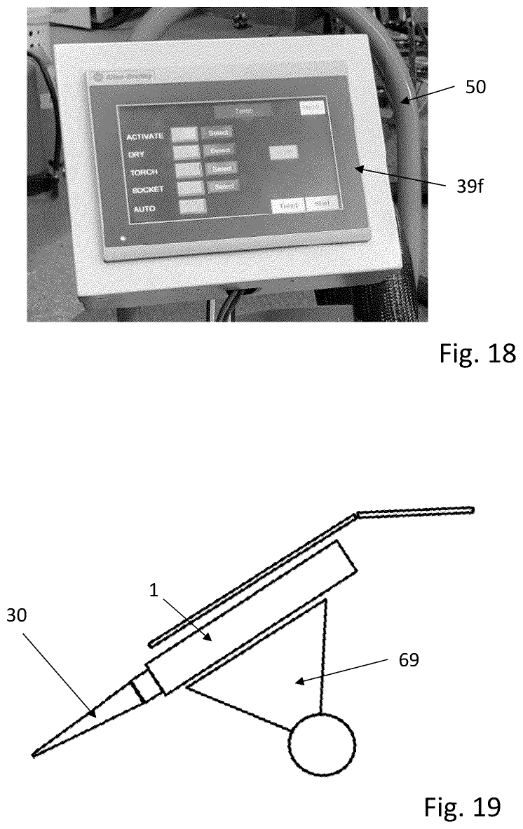

The control unit 4 comprises a control panel 39 for the operator to control the rate of flow (by controlling the volume of air delivered in a given time and/or pressure of the flow) that is to be delivered for the roofing operation (e.g. as shown in the Figures, the control panel 39 may be arranged on the front 34F of the housing 34). The control panel 39 may comprise controls (including, for example as shown in FIG. 5, a three position on/off switch 39a and an emergency stop button 39b), and may comprise lights and/or a display to indicate a status of the control unit 4 (for example, as shown in FIG. 5, one or more operation lights 39c for indicating the mode of operation of the fan unit 36 and a maintenance light 39d for indicating if maintenance is required). The control unit 4 may also comprise one or more socket outlets 39e for providing power to other tools useful for the roofing operation. In the configuration shown, there are three socket outlets 39e, each of which may correspond to a phase of a three phase supply input to the control unit 4. Each of the socket outlets 39e may therefore provide a regular alternating current output for other electrical tool. As shown in FIG. 8, the electronics of the components of the control panel 39 may be arranged inside the housing 34. FIG. 18 shows an exemplary electronic display screen 39f providing control functions for the electric torch apparatus that can be mounted to the control unit 4 or a trolley 50 being used to manoeuvre the control unit 4, for ease of use by the operator. The electronic display on the screen 39f may set heat and flow characteristics of the hot air produced by the electric torch 1 for operations like activating a roofing felt/membrane, drying an area of a deck, providing roofing torch characteristics like melting bitumen, selecting sockets and/or providing other functions, at a press of a button on the screen 39f.

Thus, apart from such a screen 39f or controls on the electric torch 1 itself, all major electronic components (electronic control components 38 and control panel components 39, albeit the internal parts thereof), which are required for the control of and/or power for the electric torch apparatus 100 during roofing operations (e.g., carrying the high levels of electrical current), may be arranged completely within the housing 34, and in particular may be arranged within a flow of air through the housing 34 generated for supply to the electric torch 1.

As discussed above, in the described embodiment the fan unit 36 is positioned at the top of the housing 34 of the control unit 4. In order to improve the stability of the control unit 4, it may be provided with a trolley 50. In other words, as shown in the embodiment in FIGS. 4-9 and schematically in FIG. 10, the control unit 4 is mounted on a trolley 50 (or any other type of suitable transporter, such as a wheelbarrow, cart or other chassis).

The trolley 50 is provided with a frame 48 for supporting (e.g. attachment to) the control unit 4 and a set of wheels 52 (e.g. one or more wheels, preferably a pair of wheels 52) for ease of transport of the control unit 4 on a roofing site. The trolley 50 may also be fitted with an electronic display screen 39f as shown in FIG. 18.

As can be seen in the embodiment shown in FIG. 4, the trolley 50 is provided with a bracket 54 configured to hold the electric torch 1 and/or the flexible hose 6 when the electric torch 1 is not in use. As the flexible hose 6 may include a cable (not shown) for transferring electrical power from the control unit 4 to the electric torch 1 for powering the electrically powered heater 5a, the electric torch 1 may stay connected to the control unit 4 during periods of non-use, and the provision of the bracket 54 allows the electric torch 1 to be stowed for transportation during such periods of non-use.

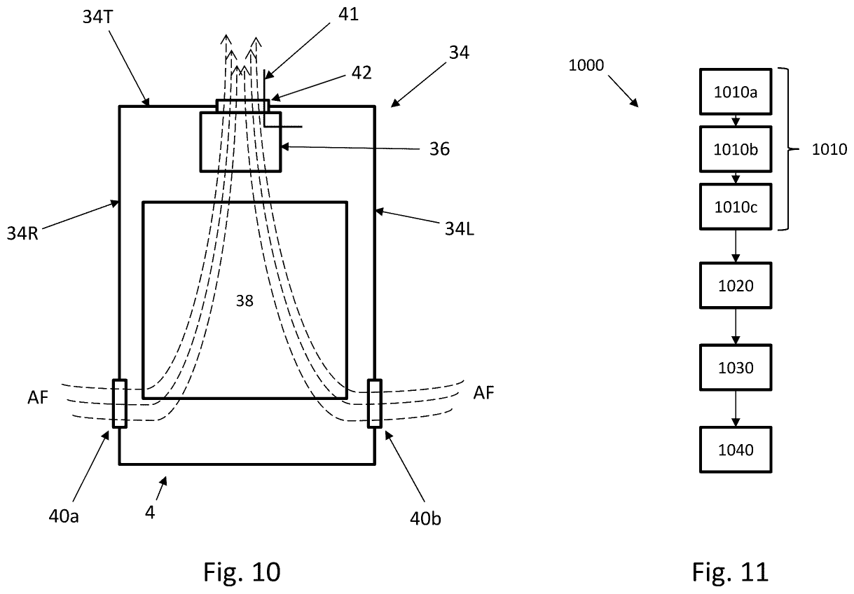

A method of providing a working flow of air for a roofing operation using the electric roofing torch apparatus 100 described above will now be described with reference to FIGS. 10 and 11.

The method 1000 comprises generating 1010, using the fan unit 36, a flow of air AF for the electric roofing torch 1. The generating 1010 of the flow of air for the electric roofing torch 1 includes drawing 1010a the air from the at least one air inlet 40a, 40b, drawing 1010b the air through the housing 34 and over the electronic control components 38, and drawing 1010c the air out through the air outlet 42.

The method comprises directing 1020 the flow of air AF from the air outlet 42 of the housing 34 to the electric roofing torch 1 through the flexible hose 6.

The method may comprise heating 1030 the flow of air using the electrically powered heater 5a mounted in the tubular body 2 of the electric roofing torch 1 to heat the flow of air as it passes through the tubular body 2 from the upstream end 2a to the downstream end 2b of the tubular body 2.

The method may comprise directing 1040, using a nozzle outlet 8, a flow of hot air for use in a roofing operation. In an embodiment, directing the flow of hot air may comprise focusing the flow of hot air through a delivery nozzle 30 fitted to the nozzle outlet 8. The flow of hot air may be used to dry an area of roof or ground in preparation for a roofing operation. The flow of hot air may be used for melting or otherwise activating a bitumen-based roofing felt or other roofing felt material that is required to be welded to a surface. The flow of hot air may be used for other non-roofing related operations too where heated air provided by an electrically heated source is required.

FIG. 12 shows a perspective view of an exemplary electric torch with a region of housing (specifically the inner tube 9 of the tubular body 2) removed, showing an arrangement of wires (heater elements) for an electrically powered heater 5a, which is equivalent in function to the heater matrix 5a shown in FIG. 2, albeit the arrangement has been found to allow higher flows of air and higher temperatures to be achieved for the air.

In this arrangement of FIG. 12, the electric torch 1 comprises a cylindrical core 60 extending longitudinally along a longitudinal axis A of the electric torch 1. At the leading edge of the core 60 (i.e., the inlet end), a nose cone 61 is provided to deflect air around an end of the core 60 and into an annular air passage 62 defined between an outer surface 60a of the core 60 and an inner surface of the housing 9 (inner tube 9 of the tubular body 2). A similar conical housing part 63 to that indicated at the outlet end is provided over the nose cone 61 in the assembled electric torch 1 to provide a divergent passage into the annular air passage 62.

The core 60 may have a diameter of 40 mm or greater, more preferably 50 mm or greater. The inner surface of the housing 9 may have an internal diameter of 100 mm or greater. The region between provides an annular air passage 62 having a radial depth of 40 mm or more. The length of the annular air passage 62 may be 300 mm or longer, more preferably 400 mm or longer.

As seen in FIG. 12, the core 60 is provided with a plurality of radially extending supports 64 (64a, 64b) for the spirally formed heater elements, namely heater wires 65. The radially extending supports 64 in this arrangement comprise a radially inner support portion 64a and a pair of radially outer support portions 64b, one arranged on each side of the radially inner support portion 64a. The radially inner support portions 64a are provided with a series of formations 64c in the form of slots located at intervals along a radially outer edge. As shown, a set of spirally wound heater wires 65 are wound around the radially inner support portions 64a and located in slots to fix their positions within the annular air passage 62. The spiral form of the heater wires 65 and the slot-shape of the formations 64c may locate the heater wires 65 in a fixed axial, radial and circumferential position within the annulus of the annular air passage 62 (albeit allowing for expansion and contraction of the heater wires 65). This can avoid the risk of heater wires 65 touching even under extreme air speeds within the electric torch 1. The radially outer support portions 64b are provided with formations 64c in the form of slots at intervals along a radially inner edge, which fit over the spirally wound heater wires 65. The radially outer support portions 64b are also provided with formations 64c in the form of slots at intervals along their radially outer edges for a further set of spirally wound heater wires 65 to be located in, to fix their positions within the annular air passage 62. Each of the supports/support portions 64, 64a, 64b, may be provided with series of six or more such formations 64c along a radially inner/outer edge, preferably ten or more such formations 64c. Additional formations 64c may be provided in the form of circular or oval openings for a heater wire 65 to extend through as necessary.

In the arrangement shown there are nine radially inner support portions 64a, spaced at 40° apart arranged around the core 60, and eighteen radially outer support portions 64b spaced at an angular displacement of 10° on either side of the radially inner support portion 64a. Each radially inner support portion 64a and associated pair of radially outer support portions 64b may provide a Y-shaped support 64 when viewed in the axial direction. Using this type of arrangement, the heater wires 65 are supported at regular and comparatively short intervals along each spiral-loop. Other numbers and arrangements of supports 64/support portions 64a, 64b are possible.

A retaining ring 66, e.g., of a high temperature stainless steel, may pass through the radially inner and radially outer support portions 64a, 64b to hold them in place. Spacers may be provided on the retaining ring 66 to locate sides of each support portion 64a, 64b in its angular position.

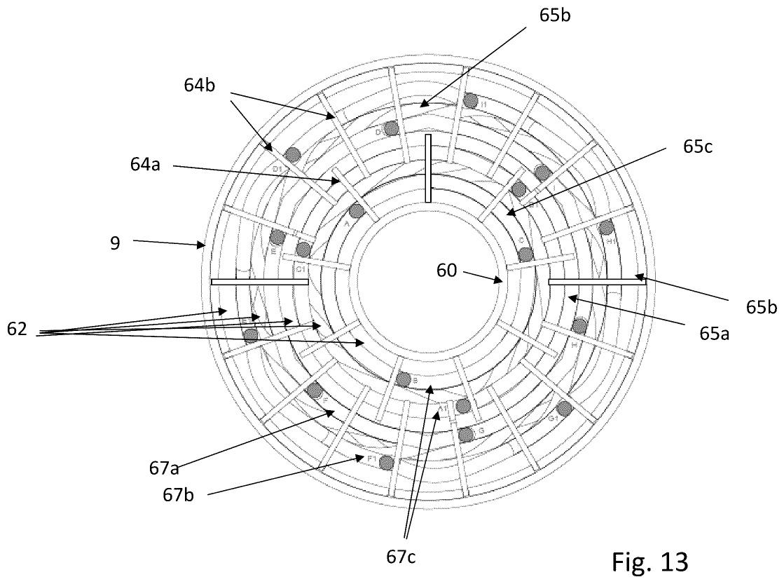

The spirals of heater wires 65 encircle the core 60, each with a spiral-loop/winding diameter between that of the core 60 and the inner tube 9 of the electric torch 1. The heater wires 65 are arranged with their spirals intertwined to provide tubular arrays 67a, 67b, 67c of heater wires 65, where a first set of intertwined heater wires 65 of a larger winding diameter (tubular array 67a, see FIG. 13) are arranged to spiral around a second set of intertwined wires of smaller winding diameter (tubular array 67b, see FIG. 13), thereby providing two tubular arrays of spirally wound heater wires 65. In the arrangement shown in FIGS. 12 and 13, a radially inner tubular array 67b of spirally wound heater wires 65a is concentrically arranged within a radially outer tubular array 67a of spirally wound heater wires 65b.

Each of the tubular arrays 67a, 67b of wires 65 is arranged as an intertwined spiral of heater wires 65, where the spirally wound heater wires 65 of each tubular array 67a, 67b have substantially the same spiral form and are arranged to follow each other in sequence in the axial direction A, the heater wires 65 each being angularly displaced from the next about the longitudinal axis A in order to space the heater wires 65 within each array as evenly as possible. Viewed another way, the heater wires 65 are arranged as a multiple helix, for example, a triple (or more) helix structure in each of the tubular arrays 67a, 67b of heater wires 65. The heater wires 65 may each be spaced from a neighbouring heater wire 65 by more than, say, 5 mm in any direction in order to prevent localised overheating. They may be angularly spaced by 25° or more.

The supports 64 can be made from mica or a mica-based material to provide high temperature compressive strength and stiffness to support the heater wires 65 in their spaced relationship at temperatures exceeding 750° F. (400° C.), and more preferably exceeding 930° F. (500° C.), and locally potentially exceeding 1100° F. (590° C.). The supports 64 may be laser cut to provide the arrays of formations 64c along their length. The supports 64 may be relatively thin, for example, of the order of 2 mm or thinner, preferably less than 1 mm thick.

FIG. 13 shows an end view of the arrangement of heater wires 65 in FIG. 12 looking along the longitudinal axis A in FIG. 12. The Y-shaped arrangement of the radially inner support portions 64a and radially outer support portions 64b can be seen more easily. The angular spacings of the ends of the heater wires can also be seen. In this example, heater wires D to I provide a twin tubular array 67a, 67b of heater wires 65, and heater wires A-C provide an additional tubular array 67c in a radially innermost region of the annular air passage 62 spaced from the core 60. In FIG. 13, the arrows indicate the areas where air is relatively unobstructed to flow through in the axial direction A.

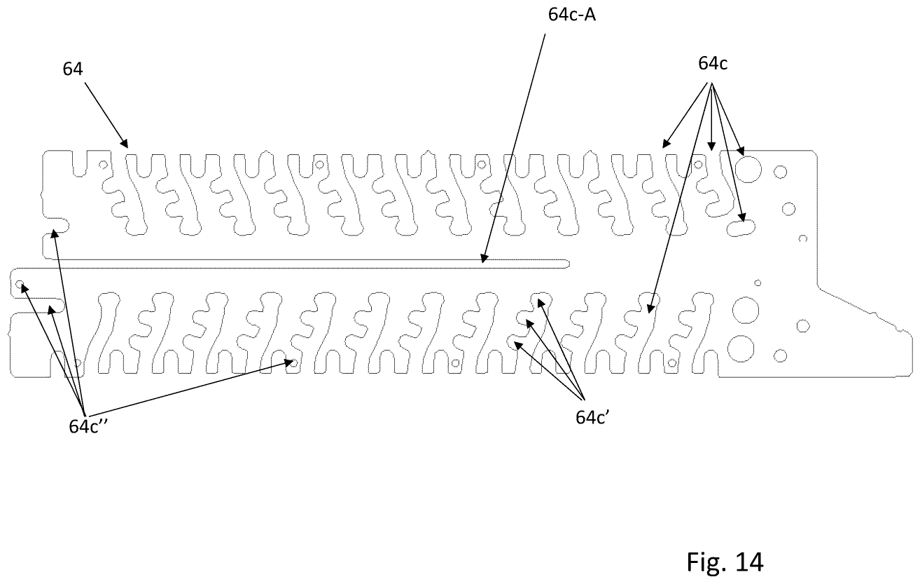

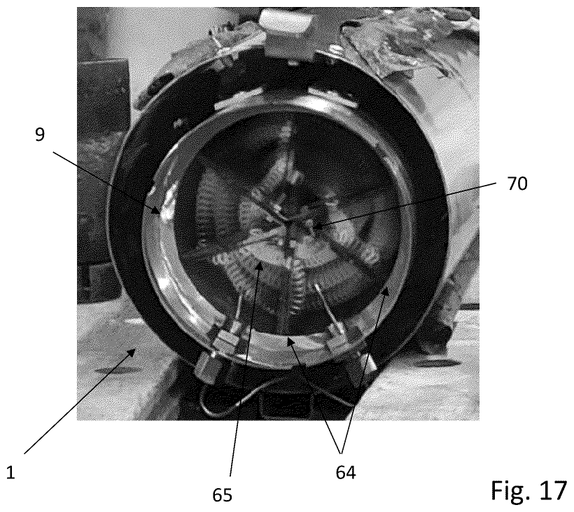

FIG. 14 shows a side view of a support 64 for supporting wires 65 within an electrically powered heater of an electric torch in a further arrangement (see FIGS. 16 and 17). This support 64 may be made of a heat resistant material like a sheet of mica, and formed in the same way as described above, e.g., by laser cutting. In this way, it is possible to generate relatively complicated patterns of formations 64c, for example, approaching a dendritic pattern as shown. The formations 64c may provide multiple points 64c′ where heater wires 65 can be located in a fixed radial height within the annular air passage 62 of the electric torch 1. This can allow multiple heater wires 65 to be secured in a location 64c′ by a given formation 64c, each heater wire 65 positioned at a different radial height within the electrically powered heater 5a, for example, to provide two or more tubular arrays of heater wires 65.

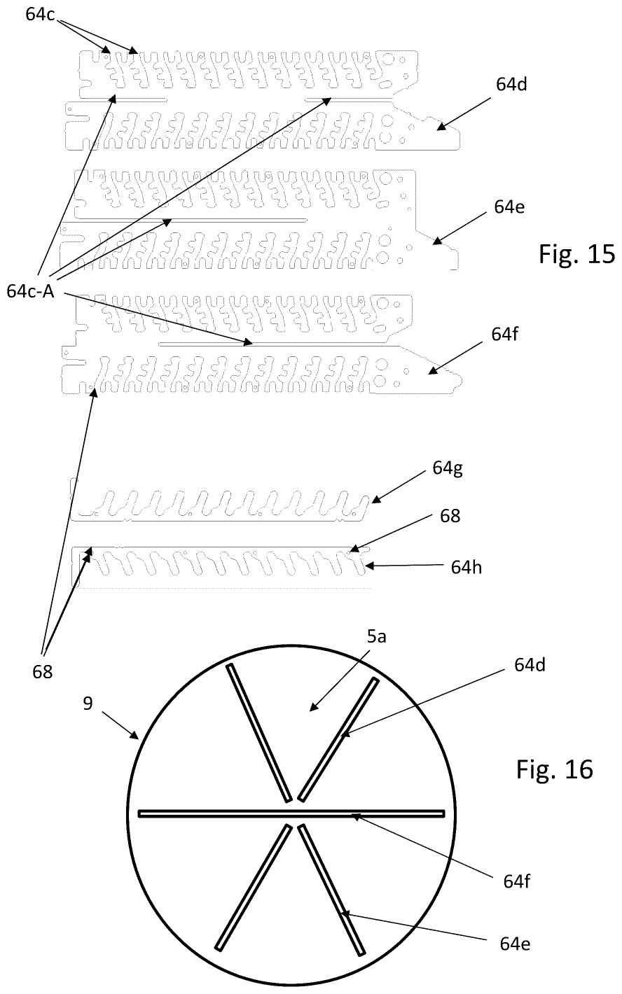

A formation in the form of an axially arranged slot 64c-A may be provided for assembling the supports 64 together (as will be explained further in FIG. 15). Further formations 64c″ may be provided at various locations to assist with the assembly process.

FIG. 15 shows a set of five supports 64 labelled 64d to 64h. The first three of the supports 64d to 64f are formers which extend radially on opposite sides of the longitudinal axis. Each of the formers 64d to 64f are provided with a different shape of an axially arranged slot or slots 64c-A such that the three formers 64d to 64f can be slotted together to form the assembled support 64, for supporting the heater elements (heater wires) 65 that are wound spirally around it, each support 64 being separated from the next by an angular displacement of 120° to provide 60° segments for the heater elements 65 to extend across.

FIG. 16 shows a schematic end view of an assembled set of supports 64d, 64e and 64f of FIG. 15 arranged in an electrically powered heater 5a (with the heater wires omitted for case of understanding). The supports 64d, 64e, 64f are arranged with hexagonal symmetry, with formations in the form of axial slots 64c-A that interlock by slotting into each other at 120° to one another to provide the assembled support 64.

FIG. 17 shows an end view of an electric torch 1 with the supports 64 installed and the heater wires 65 visible (glowing red evenly across the electrically powered heater 5a in use) within an air passage provided by the inner tube 9 of the housing. The supports 64 are as described with reference to FIGS. 15 and 16. Fasteners, like bolts 70, e.g., of stainless steel, are visible holding the supports 64 together, though other fastening arrangements are possible, for example, loops of wire or similar, passing through holes 68 in the supports 64.

FIG. 19 shows a schematic side view of an electric torch 1 mounted on a wheeled chassis 69 for use as a podium deck dryer. The electric torch 1 may use an external fan unit 36 to provide the forced flow of air or it may include a locally housed fan unit positioned in an upstream inlet of the electric torch 1. The electric torch 1 has an electrically powered heater 5a within the tubular body of the electric torch 1, for example, as described above in relation to FIGS. 12 to 17, for heating the flow of air to high operating temperatures sufficient to perform roofing operations. At a downstream end of the electric torch 1, a nozzle 30 is fitted to direct heated air at a working surface that is being prepared, for example, a podium deck of a building that needs to be dried/thawed out, in preparation for a roofing felt/membrane being laid. The nozzle 30 may be in the form of a blade to direct a horizontal film of hot air at the working surface.

The electric torch 1 having an electrically powered heater 5a as described with reference to FIGS. 12 to 17 and 19, may include any or all of the features described in relation to the electric torch apparatus described with reference to FIGS. 1 to 10, and for example, used in the method of FIG. 11.

For example, the electric torch 1 may include the carriage 12, control joystick 21 and arm sling 22 of the embodiment illustrated in FIG. 3 for an operator to support the electric torch 1 under their arm. The electric torch 1 may also be incorporated into a stand or handling apparatus, such as a felt handler apparatus or a trolley, for directing a source of hot air at a working surface while the weight of the electric torch is supported by the apparatus, for example, for when drying surfaces or when welding or activating roofing felt/membrane products. The electric torch 1 may also be connected to a control unit 4 using a flexible hose 6 as shown in FIGS. 1 to 10, as described above. The control unit 4 may be connected to a mains three-phase supply for providing the electrically powered heater 5a with electricity.

Thus, there has been described an electric roofing torch apparatus and a method of providing a heated flow of air for a roofing operation using such apparatus where the flow of air which is generated for the electric roofing torch is drawn over electronic control components 38 within the control unit 4 to provide a form of cooling. There has also been described an electric torch 1 with an electrically powered heater 5a which is in the form of tubular arrays 67a, 67b of spirally wound heater elements (heater wires) 65 arranged concentrically within an annular air passage 62.

1. An electric torch apparatus comprising:
an electric torch;
a control unit for providing a source of electrical power to the electric torch, the control unit also being able to generate a flow of air to be supplied to the electric torch during operation of the electric torch, the control unit comprising a housing with at least one air inlet and an air outlet, the housing containing a fan unit for generating the flow of air and containing a plurality of electronic control components for controlling the operation of the electric torch and the fan unit; and
a flexible hose for connecting the control unit to the electric torch, the flexible hose being configured to direct the flow of air from the air outlet of the control unit into the electric torch;
wherein the at least one air inlet and the air outlet of the control unit are arranged in the housing so that the housing provides a conduit for directing air between the at least one air inlet and the air outlet, such that when the flow of air is generated by the fan unit, air is drawn in through the at least one air inlet into the control unit, is drawn over the electronic control components within the housing by the fan unit and forced out through the air outlet into the flexible hose for supplying the flow of air to the electric torch.

2. The electric torch apparatus as claimed in claim 1, wherein the at least one air inlet is arranged in a lower portion of the housing and the air outlet is arranged in an upper portion of the housing.

3. The electric torch apparatus as claimed in claim 2, wherein the air outlet is arranged on a top side of the housing and the fan unit is positioned in the housing at the air outlet.

4. The electric torch apparatus as claimed in claim 1, wherein the housing of the control unit comprises a first air inlet on a first side and a second air inlet on a second side, positioned opposite to the first air inlet.

5. The electric torch apparatus as claimed in claim 1, wherein a cable extends within the flexible hose arranged to convey electrical power from the control unit to power an electrically powered heater of the electric torch.

6. The electric torch apparatus as claimed in claim 1, wherein the control unit is provided with a set of wheels for an operator to manoeuvre the control unit.

7. The electric torch apparatus as claimed in claim 1, wherein the fan unit comprises a centrifugal fan blower having an output aperture aligned with an inlet to the flexible hose.

8. The electric torch apparatus as claimed in claim 1, wherein the fan is capable of generating volumes of air flow that are in excess of 400 m³/h with speeds of air flow in excess of 80 km/h.

9. The electric torch apparatus as claimed in claim 1, wherein the electronic components comprise two or more of a solid-state relay, a main monitor relay, electrical connection terminals, one or more contactor relays, one or more switch relays, a fan relay, a controller, a power supply, one or more fuses, an isolator power switch, one or more residual current circuit devices, and one or more miniature circuit breakers.

10. The electric torch apparatus as claimed in claim 1, wherein the electric torch comprises a carriage mounted on an outer surface of the electric torch, the carriage providing a sling or arm hoop for carrying the electric torch on an arm of an operator and comprising a control for the operator to control temperature and/or a flow rate of the flow for a roofing or other operation.

11. The electric roofing torch apparatus as claimed in claim 1, wherein the electric torch comprises:
a tubular body having an upstream end and a downstream end, wherein the upstream end is configured for fluid connection to the flexible tube to receive the flow of air from the flexible hose; and
an electrically powered heater mounted in the tubular body to heat the flow of air as it passes through the tubular body.

12. The electric torch apparatus as claimed in claim 11, wherein the tubular body comprises a double-walled structure comprising an inner tube and an outer tube, the inner tube housing the electrically powered heater.

13. The electric torch apparatus as claimed in claim 12, wherein the outer tube provides an external housing for the electric roofing torch, the external housing being configured to shield an operator from heat from the electrically powered heater whilst the operator is holding the electric torch.

14. The electric torch apparatus as claimed in claim 13, wherein the electric torch comprises a conical inlet at the upstream end of the tubular body, the flexible hose connecting to a narrow end of the conical inlet to direct the flow of air into the inner tube of the tubular body at a wider end of the conical inlet, wherein the outer tube extends axially over the conical inlet for distance equal or greater than a length of the conical inlet.

15. An electric torch comprising:
a housing providing a longitudinal axis of the electric torch;
an air passage extending through the housing; and
an electrically powered heater arranged longitudinally within the air passage, wherein the electrically powered heater comprises a plurality of spirally wound heater elements, the heater elements being held radially, axially and circumferentially in position by radially extending supports, each support comprising formations for locating the heater elements within the air passage, wherein the heater elements are angularly spaced about the longitudinal axis and spirals of the heater elements are intertwined to provide one or more tubular arrays of heater elements extending along the longitudinal axis, the heater elements each following a spiral path substantially parallel to a neighbouring heater element in the tubular array, at least for a portion of the electrically powered heater.

16. The electric torch of claim 15, wherein the electrically powered heater comprises two or more tubular arrays of spirally wound heating elements arranged concentrically within the air passage of the electric torch.

17. The electric torch of claim 15, wherein the electrical torch has an air inlet arranged upstream of the air passage for connection to a flexible hose leading to a fan unit for supplying a flow of air into the electrical torch.

18. The electric torch of claim 17, wherein the electric torch is connected to a control unit containing the fan unit via the flexible hose for supplying a flow of air to the electric torch, the flexible hose containing a cable for transferring electrical power from the control unit to the electrically powered heater of the electric torch.

19. A method of providing a heated flow of air for a roofing operation using the electric torch apparatus as claimed in claim 1, the method comprising:
generating, using the fan unit, a flow of air for the electric torch; and
directing the flow of air from the air outlet of the control unit to the electric torch through the flexible hose;
wherein the generating the flow of air for the electric torch includes drawing the air into the control unit through the at least one air inlet, drawing the air over the electronic control components within the housing, and forcing the air out through the air outlet into the flexible hose and the electric torch.

20. The method as claimed in claim 19, wherein the method comprises:
heating the flow of air using an electrically powered heater mounted in the tubular body of the electric torch to heat the flow of air as it passes through the tubular body from an upstream end to a downstream end of the tubular body.
